(19) United States
(12) Patent Application Publication
(10) Pub. No.: US 2016/0122538 A1
(43) Pub. Date: May 5, 2016

(54) SEALING MATERIAL

(71) Applicant: JTEKT CORPORATION, Osaka (JP)

(72) Inventor: Yohei SHIMIZU, Kashiwara-shi (JP)

(21) Appl. No.: 14/928,238

(22) Filed: Oct. 30, 2015

(30) Foreign Application Priority Data
Oct. 30, 2014 (JP) 2014-221737
Sep. 2, 2015 (JP) 2015-173004

(51) Int. Cl. C08L 71/03; C08L 1/02

(52) U.S. Cl. CPC C08L 71/03; C08L 1/02

(57) ABSTRACT

Provided is a sealing material used for sealing high-pressure hydrogen. The sealing material is a molded article of a rubber composition containing a rubber component, fibers, and a carbon black.

### INCORPORATION BY REFERENCE

The disclosure of Japanese Patent Applications No. 2014-221737 and 2015-173004 filed on Oct. 30, 2014 and Sep. 2, 2015 each including the specification, drawings and abstract is incorporated herein by reference in its entirety.

### BACKGROUND OF THE INVENTION

1. Field of the Invention

The present invention relates to a sealing material and specifically relates to a sealing material used in an environment in which the sealing material is exposed to high-pressure hydrogen.

2. Description of Related Art

In recent years, hydrogen energy has been drawing attention as a novel secondary energy source in place of electricity. Hydrogen has a small energy density per unit volume and thus is required to be stored at high pressure (for example, 100 MPa at hydrogen stations) for efficient use as the energy source. Containers for storing hydrogen and apparatuses for supplying the stored hydrogen thus need sealing materials.

The behavior of the sealing material in a high-pressure hydrogen environment is still unclear in many aspects, and at existing trial hydrogen stations, typical O-rings or the like are used as the sealing materials. However, it is difficult to say that the O-rings currently used satisfy demand characteristics for the hydrogen stations in terms of durability and the like.

For example, Japanese Patent Application Publication No. 2002-228078 (JP 2002-228078 A) discloses a resin connector including two different types of O-rings, and describes that the resin connector has excellent barrier properties to hydrogen gas. Although the O-rings used in the resin connector are two different types of O-rings, each O-ring is a typical O-ring and has insufficient durability against high-pressure hydrogen.

### SUMMARY OF THE INVENTION

As described above, the O-rings currently used at hydrogen stations and the like unfortunately have insufficient durability, and it is difficult to prevent the existing O-rings from suffering from failure (for example, blister fracture, extrusion fracture, buckling failure) due to high-pressure hydrogen over a long period of time. For example, in the case of a vehicle to which hydrogen is supplied from a hydrogen station, the O-ring used in a receptacle of the vehicle is repeatedly exposed to a hydrogen having a temperature of from about −40 to 50° C. and a pressure of from atmospheric pressure to about 90 MPa. It has been difficult to use the existing O-rings in such a hydrogen atmosphere over a long period of time. The present invention provides a sealing material having excellent durability in an environment in which the sealing material is exposed to high-pressure hydrogen and capable of sealing high-pressure hydrogen over a long period of time.

The inventors of the present invention have found that the following characteristics are important for the sealing material: the sealing material is unlikely to accumulate hydrogen in the inside thereof when exposed to high-pressure hydrogen; hydrogen immediately escapes from the inside of rubber when the hydrogen atmosphere is suddenly decompressed; and the volume expansion is unlikely to occur when the hydrogen atmosphere is suddenly decompressed.

That is, a sealing material in an embodiment of the present invention is a sealing material used for sealing high-pressure hydrogen, and is characterized in that the sealing material is a molded article of a rubber composition containing a rubber component, fibers, and a carbon black. In the sealing material of the embodiment of the invention, fibers and a carbon black are contained in a rubber. In a sealing material containing the fibers, voids are formed between the fibers and the rubber. The voids become routes for allowing hydrogen gas to escape when the sealing material is exposed to high-pressure hydrogen and is oversaturated with the hydrogen gas. In addition, in a sealing material containing the carbon black, hydrogen gas is adsorbed on the surface of the carbon black, and this can reduce the amount of the hydrogen gas released from the sealing material when the pressure is suddenly reduced. On this account, the sealing material can satisfy the above characteristics, is unlikely to cause fracture due to high-pressure hydrogen, and can seal high-pressure hydrogen over a long period of time.

In the present invention, the high-pressure hydrogen means a hydrogen having a pressure of 10 MPa or more. The sealing material of the embodiment can seal the high-pressure hydrogen, and can naturally seal a hydrogen having a pressure of less than 10 MPa together with the high-pressure hydrogen.

In the sealing material in the embodiment, the rubber component may be an epichlorohydrin rubber, and the fibers may be cellulose fibers. Such a sealing material is particularly excellent in terms of a small change in volume and a small hydrogen content when exposed to high-pressure hydrogen.

In the sealing material in the embodiment, the fibers may have an average fiber length of 30 to 150 μm and be contained in an amount of 7 to 9 parts by weight relative to 100 parts by weight of the rubber component. When the fibers are contained in such conditions, voids can be appropriately formed between the rubber and the fibers in the sealing material.

In the sealing material in the embodiment, the carbon black may have an average particle size of 10 to 70 nm and be contained in an amount of 8 to 11 parts by weight relative to 100 parts by weight of the rubber component. By containing the carbon black in such conditions, the sealing material is reliably prevented from suffering from fracture when used.

In the sealing material in the embodiment, the rubber composition may further contain a reinforcing agent. When the rubber composition contains the reinforcing material, the sealing material can be more reliably prevented from being deformed when exposed to high-pressure hydrogen and can more reliably achieve durability and sealing performance against high-pressure hydrogen. The reinforcing agent may be silica. This is because the silica is suitable for achieving the function as the reinforcing agent and is available at low cost. The reinforcing agent may be contained in an amount of 60 to 80 parts by weight relative to 100 parts by weight of the rubber component. This case is particularly suitable for satisfying both the strength and the flexibility of the sealing material.

In the sealing material in the embodiment, the rubber composition may further contain a plasticizer. When containing the plasticizer, the rubber composition can impart flexibility to the sealing material and can be more reliably achieve the sealing performance of the sealing material. The plasticizer may be an adipic acid ether ester plasticizer. The adipic acid ether ester plasticizer can reliably exert the function as the plasticizer even at low temperatures, and thus the sealing material can reliably achieve excellent sealing performance even when used at low temperatures. The plasticizer may be contained in an amount of 40 to 60 parts by weight relative to 100 parts by weight of the rubber component. Such a rubber composition can be reliably impart flexibility to the sealing material and can more reliably prevent the sealing material from being greatly deformed and from losing the sealing performance at high temperatures.

The sealing material in the embodiments of the present invention has excellent durability when exposed to high-pressure hydrogen (in a high-pressure hydrogen environment). Therefore, the sealing material can reduce the exchange frequency when used, has excellent maintenance properties, and reduces running costs.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic view of an on-site hydrogen station;

FIG. 2 is a sectional view for illustrating the connection between a hydrogen supply plug at a hydrogen station side and a receptacle at a vehicle side;

FIG. 3 is a sectional view illustrating an example high-pressure hydrogen storage container;

FIG. 4 is a SEM image of a cross section of a sealing material produced in Example;

FIG. 5 is a graph illustrating the test result of delay time in Example and Comparative Example; and

FIG. 6 is a graph illustrating the test result of hydrogen solubility coefficient in Example and Comparative Example.

### DETAILED DESCRIPTION OF EMBODIMENTS

A sealing material in embodiments of the present invention is a molded article of a particular rubber composition. The rubber composition will first be described. The rubber composition contains at least a rubber component, fibers, and a carbon black.

The rubber component can be rubber components used in known sealing materials, and is exemplified by epichlorohydrin rubbers such as polyepichlorohydrin (CO), epichlorohydrin-ethylene oxide copolymers (ECO), epichlorohydrin-allyl glycidyl ether copolymers (GCO), and epichlorohydrin-ethylene oxide-allyl glycidyl ether terpolymers (GECO), ethylene-propylene-diene rubbers (EPDM), ethylene-propylene rubbers (EPR), silicone rubbers (VMQ, FVMQ), fluorocarbon rubbers (FKM), natural rubbers (NR), isoprene rubbers (IR), butyl rubbers (IIR), nitrile isoprene rubbers (NIR), and hydrogenated nitrile rubbers (HNBR). As the rubber component, thermoplastic elastomers such as olefinic thermoplastic elastomers (TPO) can also be used. Among them, epichlorohydrin rubbers are preferred. This is because such rubbers are suitable for achieving high performance even when used at low temperatures. Of these rubber components, two or more rubber components can be blended and used.

When the rubber component is a cross-linkable rubber component, the rubber composition may contain a crosslinking agent. The crosslinking agent can be a known crosslinking agent, which can be appropriately selected depending on the type of the rubber component. Examples of the crosslinking agent include sulfur crosslinking agents, thiourea crosslinking agents, peroxide crosslinking agents, and triazine derivative crosslinking agents.

The fibers are not limited to particular fibers, and can be inorganic fibers or organic fibers. Examples of the inorganic fibers include glass fibers, rock wool, ceramic fibers, and carbon fibers. Examples of the organic fibers include polyolefin resin fibers, polyester resin fibers, polyurethane resin fibers, polyamide resin fibers, aramid resin fibers, acrylic resin fibers, cotton fibers, and cellulose fibers. These fibers can be used singly or in combination of two or more types. The fibers are preferably organic fibers and more preferably cellulose fibers. This is because such fibers are particularly suitable for forming microscopic voids on the interface between the rubber and the fibers due to the difference in compatibility.

The preferred lower limit of the average fiber length of the fibers is 30 μm. The preferred upper limit of the average fiber length is 150 μm.

In the rubber composition, the preferred lower limit of the amount of the fibers is 5 parts by weight relative to 100 parts by weight of the rubber component. If the fibers are contained in an excessively small amount, voids that become routes for allowing hydrogen gas to escape cannot be sufficiently formed in the sealing material in some cases. The lower limit of the amount of the fibers is more preferably 7 parts by weight relative to 100 parts by weight of the rubber component. The preferred upper limit of the amount of the fibers is 15 parts by weight relative to 100 parts by weight of the rubber component. If the fibers are contained in an excessively large amount, hydrogen excessively easily passes through the sealing material, and thus such a sealing material may lack the primary performance. The upper limit of the amount of the fibers is more preferably 13 parts by weight, even more preferably 11 parts by weight, and particularly preferably 9 parts by weight relative to 100 parts by weight of the rubber component.

In the sealing material of the present invention, as for the combination of the rubber component and the fibers, the rubber component is preferably an epichlorohydrin rubber, and the fibers are preferably cellulose fibers. This is because the sealing material produced from such a combination has a small change in volume and a small hydrogen content when exposed to high-pressure hydrogen.

The carbon black is not limited to particular carbon blacks and is exemplified by furnace black, thermal black, channel black, acetylene black, lamp black, and ketjen black. Examples of the furnace black include super abrasion furnace (SAF), intermediate super abrasion furnace (ISAF), intermediate ISAF-high structure (IISAF-HS), high abrasion furnace (HAF), fast extruding furnace (FEF), general purpose furnace (GPF), semi-reinforcing furnace (SRF), high colour furnace (HCF), and medium colour furnace (MCF). Examples of the thermal black include fine thermal (FT) and medium thermal (MT). Among them, granular HCF is preferred. This is because the granular HCF has a small average particle size and has the advantage of appropriately adsorbing hydrogen. In the present invention, a single type of carbon black can be used or two or more types of carbon blacks can be used in combination, as the carbon black.

The preferred lower limit of the average particle size (primary particle size) of the carbon black is 10 nm. The preferred upper limit of the average particle size is 70 nm. If the carbon black has an excessively large average particle size, the surface of the carbon black adsorbs an excessively large amount of hydrogen gas, and the rubber composition can contain a large amount of hydrogen. The sealing material produced from such a composition may be broken due to oversaturation of hydrogen when the pressure is suddenly reduced.

In the rubber composition, the preferred lower limit of the amount of the carbon black is 5 parts by weight relative to 100 parts by weight of the rubber component. If the carbon black is contained in an excessively small amount, the sealing material produced from such a composition can trap a smaller amount of hydrogen when the pressure is suddenly reduced. This reduces a delay effect, and thus the sealing material may be broken. The lower limit of the amount of the carbon black is more preferably 8 parts by weight relative to 100 parts by weight of the rubber component. The preferred upper limit of the amount of the carbon black is 20 parts by weight relative to 100 parts by weight of the rubber component. If the carbon black is contained in an excessively large amount, the sealing material produced from such a composition traps an excessively large amount of hydrogen when the pressure is suddenly reduced. The sealing material may thus be broken due to oversaturation of hydrogen when the pressure is suddenly reduced. The upper limit of the amount of the carbon black is more preferably 17 parts by weight, even more preferably 14 parts by weight, and particularly preferably 11 parts by weight relative to 100 parts by weight of the rubber component.

The rubber composition preferably contains a plasticizer and a reinforcing agent in addition to the rubber component, the fibers, and the carbon black. The plasticizer can be a known plasticizer, which can be appropriately selected depending on the type of the rubber component. In order to allow the sealing material to reliably achieve the performance even when the sealing material is used at low temperatures, the plasticizer is preferably a cold-resistant plasticizer that can sufficiently exert the function as the plasticizer even at low temperatures. Specific examples of the plasticizer include phthalic acid derivatives (including phthalic acid ether ester plasticizers), adipic acid derivatives (including adipic acid ether ester plasticizers), and sebacic acid derivatives (including sebacic acid ether ester plasticizers). The plasticizer is preferably the adipic acid ether ester plasticizers. This is because such plasticizers are particularly suitable for exerting the plasticizer function even at low temperatures.

When the rubber composition contains the plasticizer, the preferred lower limit of the amount of the plasticizer is 30 parts by weight relative to 100 parts by weight of the rubber component. If the plasticizer is contained in an excessively small amount, the sealing material cannot achieve a required flexibility particularly at low temperatures in some cases. The lower limit of the amount of the plasticizer is more preferably 40 parts by weight and even more preferably 50 parts by weight relative to 100 parts by weight of the rubber component. The preferred upper limit of the amount of the plasticizer is 70 parts by weight relative to 100 parts by weight of the rubber component. If the plasticizer is contained in an excessively large amount, the sealing material has an excessively small hardness and thus is greatly deformed at high pressure to fail to maintain the sealing performance in some cases. The upper limit of the amount of the plasticizer is more preferably 60 parts by weight relative to 100 parts by weight of the rubber component.

The reinforcing agent is not limited to particular agents and can be a known reinforcing agent used in sealing materials. Examples of the reinforcing agent include silica. The reinforcing agent can have a surface treated with a coupling agent or a similar agent. This treatment improves the adhesion to the rubber component. Accordingly, the sealing material obtains a higher strength, is prevented from being deformed at high pressure, and consequently can have a higher sealing performance.

When the rubber composition contains the reinforcing agent, the preferred lower limit of the amount the reinforcing agent is 50 parts by weight relative to 100 parts by weight of the rubber component. If the reinforcing agent is contained in an excessively small amount, the sealing material cannot achieve sufficient strength in some cases. The lower limit of the amount of the reinforcing agent is more preferably 60 parts by weight and even more preferably 70 parts by weight relative to 100 parts by weight of the rubber component. The preferred upper limit of the amount of the reinforcing agent is 90 parts by weight relative to 100 parts by weight of the rubber component. If the reinforcing agent is contained in an excessively large amount, the sealing material has a lower flexibility and may lose the function as the sealing material. The upper limit of the amount of the reinforcing agent is more preferably 80 parts by weight relative to 100 parts by weight of the rubber component.

The rubber composition can contain various additives commonly added to sealing materials, such as process aids, age inhibitors, fillers, ultraviolet absorbers, surfactants, flame retardants, antibacterial and antifungal agents, and coloring agents, as necessary. When containing a crosslinking agent, the rubber composition can contain vulcanization accelerators, vulcanization acceleration aids, acid acceptors, and similar additives, as necessary.

The sealing material in the embodiments of the present invention is a molded article of the rubber composition. The molded article preferably has a TR10 of −65° C. or less. This is because such a sealing material has more excellent sealing performances (elasticity and gas impermeability) at low temperatures. The TR10 can be determined by the method in accordance with JIS K6261 (2006).

The sealing material of the present invention can be used as a gasket as described later. On this account, the shape thereof is not limited to particular shapes, and an appropriate shape can be selected depending on an intended purpose.

The sealing material of the present invention has the characteristics described above and thus can be preferably used as a sealing material for high-pressure hydrogen at a position that is exposed to high-pressure hydrogen. Specific examples of the application include gaskets such as O-rings for receptacles at hydrogen stations; gaskets such as O-rings for compressors at hydrogen stations; gaskets such as O-rings for pressure accumulators at hydrogen stations; gaskets such as O-rings for emergency release couplings at hydrogen stations; gaskets such as O-rings for high-pressure valves for hydrogen storage systems (power system stabilization); gaskets such as O-rings for regulators for hydrogen storage systems (power system stabilization); gaskets such as O-rings for hydrogen tanks for hydrogen storage systems (power system stabilization); gaskets such as O-rings for pumps of supplying a liquid hydrogen fuel to space rocket engines; and gaskets such as O-rings for methane hydrate drilling apparatuses.

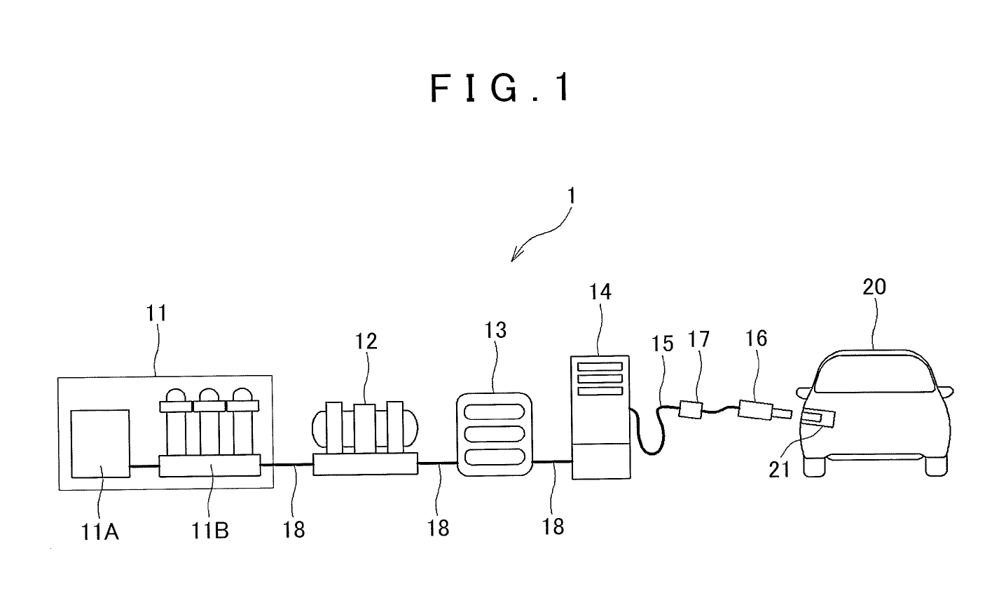

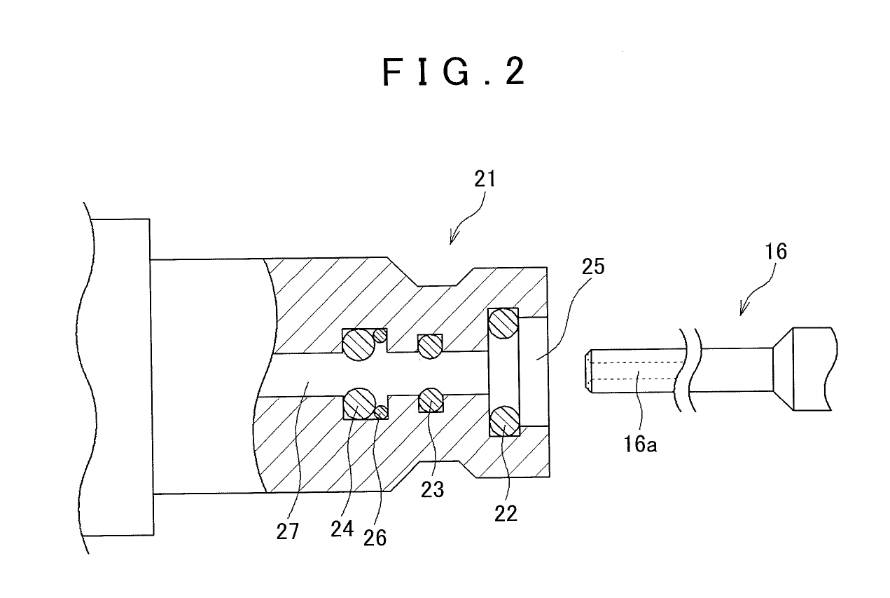

Usage examples of the sealing material of the present invention will next be described with reference to drawings. FIG. 1 is a schematic view of an on-site hydrogen station. FIG. 2 is a sectional view for illustrating the connection between a hydrogen supply plug at a hydrogen station side and a receptacle at a vehicle side.

The hydrogen station 1 shown in FIG. 1 includes a hydrogen production apparatus 11, a hydrogen compression apparatus (compressor) 12, a pressure accumulator 13, and a dispenser 14, and the respective apparatuses are connected through hydrogen pipes 18. At a midway point of each hydrogen pipe 18, piping members such as valves and joints (not shown) are provided as necessary. At the on-site hydrogen station 1, a fuel (naphtha or kerosene) is supplied from the outside, and the fuel is used to produce hydrogen with the hydrogen production apparatus 11 that is equipped with a fuel reforming apparatus 11A and a hydrogen purifying apparatus 11B for highly purifying the hydrogen. The hydrogen produced by the hydrogen production apparatus 11 is made into a high-pressure hydrogen having a predetermined pressure (for example, 95 MPa) with the hydrogen compression apparatus 12, and the compressed hydrogen is supplied to a vehicle 20 equipped with a hydrogen tank (not shown) through the pressure accumulator 13 for temporarily storing the high-pressure hydrogen and the dispenser 14 for supplying the high-pressure hydrogen stored in the pressure accumulator 13 to the vehicle 20. At this time, the hydrogen is supplied from the dispenser 14 to the vehicle 20 on the basis of differential pressure of hydrogen. For example, the pressure in the pressure accumulator 13 is adjusted to 95 MPa, the pressure in the dispenser 14 is adjusted to 82 MPa, and hydrogen is supplied to the hydrogen tank in the vehicle 20 on the basis of the differential pressure.

The dispenser 14 has a hydrogen supply hose 15 for supplying hydrogen to the hydrogen tank of the vehicle 20, and the hydrogen supply hose 15 has a hydrogen supply plug 16 that is to be removably connected to a receptacle 21 of the vehicle 20. By connecting the hydrogen supply plug 16 to the receptacle 21, hydrogen can be supplied to the vehicle 20. At a midway point of the hydrogen supply hose 15, an emergency release coupling 17 is provided. In case of emergency (for example, when the vehicle 20 erroneously starts), by activating the emergency release coupling 17, the supply of hydrogen from the hydrogen station 1 side to the vehicle 20 side can be stopped.

The receptacle 21 of the vehicle 20, as shown in FIG. 2, includes a port 25 to which the hydrogen supply plug 16 is inserted and connected, a first O-ring 22 provided near the port 25 and for sealing hydrogen, a second O-ring 23 provided at a downstream side of the first O-ring 22 from the port 25 and for sealing hydrogen, and a third O-ring 24 provided at a further downstream side of the second O-ring 23 and for sealing hydrogen. Each of the first to third O-rings 22 to 24 is fitted and provided in a corresponding groove provided on the wall surface of a flow path 27. The third O-ring 24 is fixed to the groove with a backup ring 26 that is placed adjacent to the third O-ring 24. The hydrogen supply plug 16 has a tip 16a that has a shape fitted to the port 25 of the receptacle 21. The hydrogen supply plug 16 is connected to the receptacle 21 by inserting the tip 16a of the hydrogen supply plug 16 from the port 25 of the receptacle 21. This enables the supply of hydrogen. The first to third O-rings 22 to 24 used here are the O-rings produced from the sealing material of the present invention. When hydrogen is supplied from the hydrogen station 1 to the vehicle 20, the presence of the first to third O-rings 22 to 24 enables the prevention of leakage of the hydrogen.

In the hydrogen station 1, the dispenser 14 includes a precooler (not shown) for cooling the hydrogen that is to be supplied to the vehicle 20, and the hydrogen station 1 is configured to enable the control of the temperature of the hydrogen to be supplied to the vehicle 20 at a predetermined temperature (for example, −40 to 50° C.).

The sealing material of the present invention can be used not only as the O-rings in the receptacle 21, as described above, but also as the sealing materials at positions that are exposed to hydrogen, in various apparatuses such as the emergency release coupling 17, the hydrogen production apparatus 11, the hydrogen compression apparatus 12, the pressure accumulator 13, and the dispenser 14 and in the hydrogen pipes 18 connecting the respective apparatuses.

The hydrogen station 1 can include a high-pressure hydrogen storage container for storing the produced hydrogen between the hydrogen production apparatus 11 and the hydrogen compression apparatus 12, as necessary. The vehicle 20 includes a high-pressure hydrogen storage container (hydrogen tank) for storing the supplied hydrogen. Also in these high-pressure hydrogen storage containers, the sealing material of the present invention can be used.

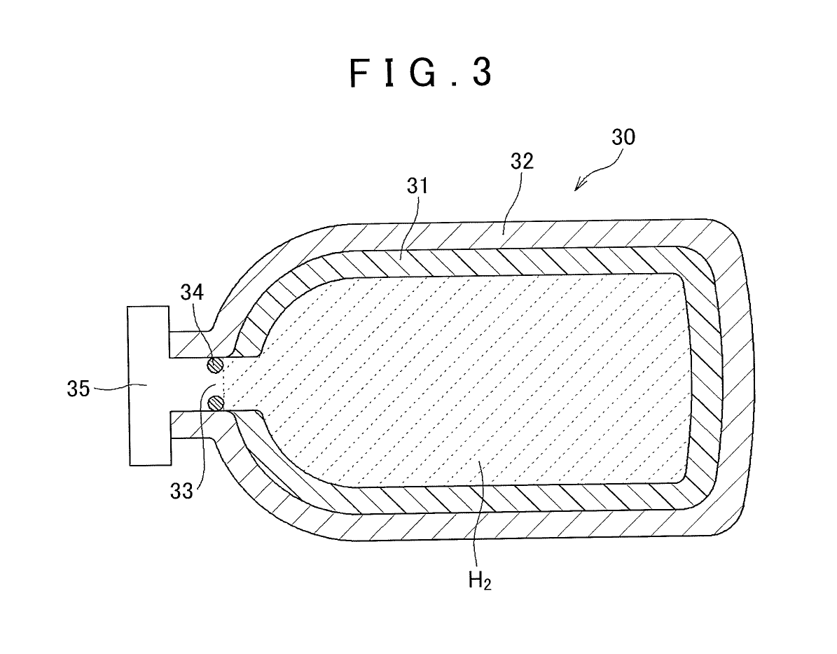

FIG. 3 is a sectional view illustrating an example high-pressure hydrogen storage container. As shown in FIG. 3, the high-pressure hydrogen storage container 30 for storing high-pressure hydrogen (H₂) has a cylindrical shape as a whole and includes a liner 31 as the container main body, an outer jacket 32 provided so as to cover the whole periphery of the liner 31, a through-hole 33 passing through the liner 31 and the outer jacket 32 and functioning as a flow path of hydrogen, and a valve 35 for allowing hydrogen to flow in and out. To the valve 35, an O-ring 34 is provided so as to prevent hydrogen from leaking. The O-ring 34 used here is the O-ring produced from the sealing material of the present invention. The liner 31 is formed of a lining material such as aluminum and resins including high-density polyethylene. The outer jacket 32 is formed of a metal such as chrome molybdenum steel or a carbon fiber reinforced plastic (CFRP) as the material. The high-pressure hydrogen storage container 30 can be not only a container capable of storing high-pressure hydrogen but also a container including a liner containing a hydrogen adsorbent that can adsorb (or store) and release hydrogen.

The sealing material of the present invention can be produced by a known method. For example, raw materials are weighed and then kneaded to give a rubber composition. The obtained rubber composition is charged in a mold and subjected to vulcanizing compression molding, yielding the sealing material. Needless to say, the sealing material can be produced by another method.

The present invention will next be described in further detail with reference to examples, but the present invention is not intended to be limited to the examples.

The raw materials described below were used, and the processes (1) to (5) were carried out, giving a sheet-like sealing material (Example 1).

### (Raw Material: Mixing Amount)

Rubber component (epichlorohydrin rubber manufactured by Daiso, EPION 301): 100 parts by weight
Fibers (cellulose fibers manufactured by Nippon Paper Chemicals, KC FLOCK 100): 8 parts by weight
Carbon black (manufactured by Asahi Carbon, SUNBLACK 930): 10 parts by weight
Plasticizer (adipic acid ether ester plasticizer manufactured by ADEKA, ADK CIZER 107): 50 parts by weight
Reinforcing agent (silica manufactured by Daiso, CABRUS SW-134): 70 parts by weight Acid acceptor (magnesium oxide): 3 parts by weight
Age inhibitor (manufactured by OUCHI SHINKO CHEMICAL INDUSTRIAL, NOCRAC NBC): 1 part by weight
Process aid (stearic acid): 2 parts by weight
Crosslinking agent (manufactured by Takehara Rubber, TR Master ETU 80E): 4 parts by weight (in terms of ethylene thiourea (ETU))

(1) Each raw material was weighed. (2) The raw materials except the crosslinking agent were placed in a BB mixer (manufactured by Kobe Steel, MIXITRONBB-L1800, an internal volume of 1.6 L). The rotation rate was gradually increased, and when the temperature reached 160° C., the mixture was discharged from the BB mixer. (3) With the mixture obtained in the process (2), the crosslinking agent was kneaded by using a twin rolling mill (manufactured by Kansai Roll, 8-inch test rolling mill) at a roll temperature of 80° C., and the mixture was molded into a sheet shape, giving an unvulcanized sheet.

(4) Next, the sheet was molded by using a 10-ton minipress (manufactured by Toyo Seiki Seisaku-sho, type N519MP-WNL) in conditions of 35 MPa, 170° C., and a Tc of 90 hours, giving a sheet with a thickness of 2 mm in which the rubber component was crosslinked. (5) The sheet obtained in the process (4) was subjected to secondary vulcanization in an oven (manufactured by Koyo Thermo Systems, Atmosphere Oven KLO series) at 170° C. for 4 hours, yielding a sheet-like sealing material.

A sealing material of Comparative Example 1 was produced in the same manner as in Example 1 except that no cellulose fibers or no carbon black was used as the raw materials.

The sealing materials produced in Example and Comparative Example were subjected to the following evaluations.

### (1) Cross Section Observation

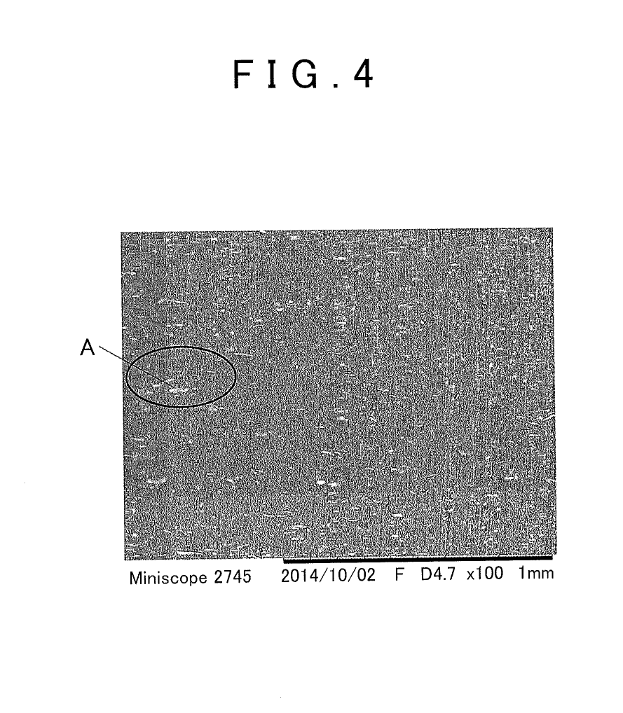

The sealing material produced in Example 1 was cut in the thickness direction, and the cross section was observed under a scanning electron microscope (SEM) (magnification: ×100). The obtained observation image is shown in FIG. 4. As shown in FIG. 4, in the sealing material of Example 1, a large number of voids (in FIG. 4, black areas surrounding white areas (see in the region A, for example)) formed by the addition of cellulose fibers were observed.

(2) Delay Time and Hydrogen Solubility Coefficient

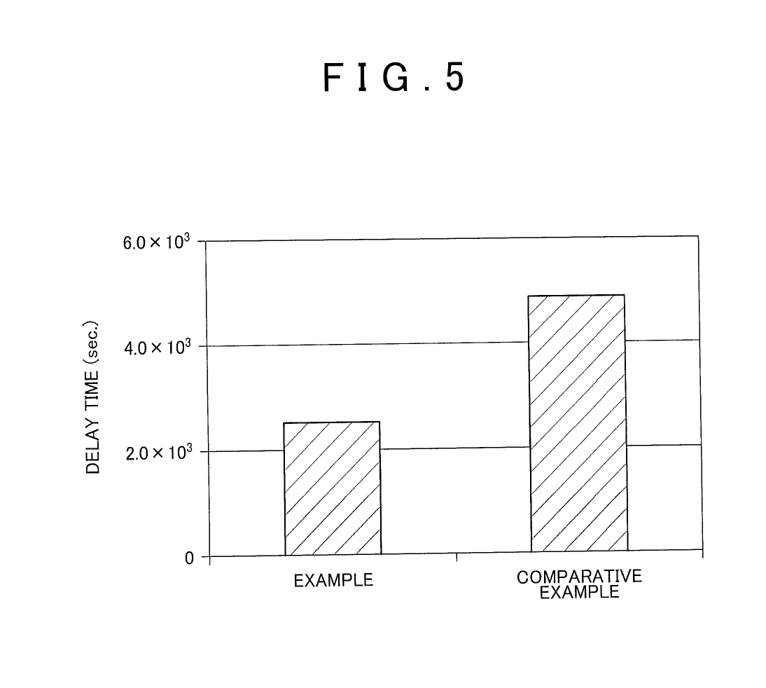

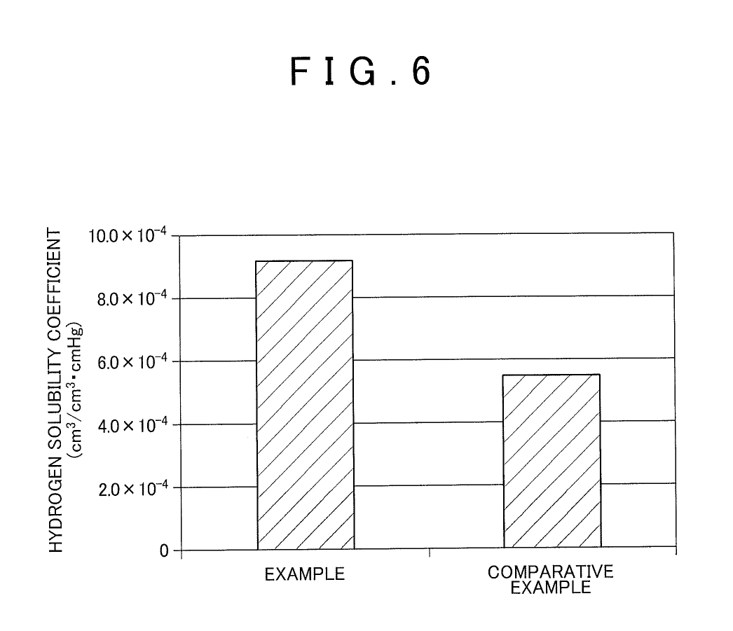

The delay time and the hydrogen solubility coefficient (ratio of permeability coefficient to diffusion coefficient (permeability coefficient/diffusion coefficient)) of each sealing material produced in Example 1 and Comparative Example 1 were determined by using a solubility coefficient/diffusion coefficient measurement apparatus (manufactured by GTR Tec, GTR-11X/11DF) in accordance with JIS 7126-1 (2006). The fluid used here was a hydrogen at a pressure of 0.3 MPa and a temperature of 30° C. As a result, the delay time of the sealing material of Example 1 was 2,532 seconds, and the delay time of the sealing material of Comparative Example 1 was 4,910 seconds, as shown in FIG. 5. The hydrogen solubility coefficient of the sealing material of Example 1 was 9.2×10⁻⁴ cm³/cm³·cmHg, and the hydrogen solubility coefficient of the sealing material of Comparative Example 1 was 5.5×10⁻⁴ cm³/cm³·cmHg, as shown in FIG. 6.

(3) Volume Change

The sealing material produced in Example 1 was exposed to hydrogen at a pressure of 90 MPa and a temperature of 30° C. for 24 hours, and then was decompressed. Whether the sealing material expanded was examined, and almost no change in volume was observed.

As described above, the sealing material of Example of the present invention had a short delay time and was unlikely to cause a volume change when exposed to hydrogen. The sealing material, which contained the fibers and the carbon black, had a larger hydrogen solubility coefficient. This is considered to be because voids are formed between the fibers and the rubber.

What is claimed is:

1. A sealing material used for sealing high-pressure hydrogen, wherein the sealing material is a molded article of a rubber composition containing a rubber component, fibers, and a carbon black.

2. The sealing material according to claim 1, wherein the rubber component is an epichlorohydrin rubber, and the fibers are cellulose fibers.

3. The sealing material according to claim 2, wherein the fibers have an average fiber length of 30 to 150 μm and are contained in an amount of 7 to 9 parts by weight relative to 100 parts by weight of the rubber component.

4. The sealing material according to claim 1, wherein the fibers have an average fiber length of 30 to 150 μm and are contained in an amount of 7 to 9 parts by weight relative to 100 parts by weight of the rubber component.

5. The sealing material according to claim 1, wherein the carbon black has an average particle size of 10 to 70 nm and is contained in an amount of 8 to 11 parts by weight relative to 100 parts by weight of the rubber component.

6. The sealing material according to claim 1, wherein the rubber composition further contains a reinforcing agent.

7. The sealing material according to claim 6, wherein the reinforcing agent is silica.

8. The sealing material according to claim 7, wherein the reinforcing agent is contained in an amount of 60 to 80 parts by weight relative to 100 parts by weight of the rubber component.

9. The sealing material according to claim 1, wherein the rubber composition further contains a plasticizer.

10. The sealing material according to claim 9, wherein the plasticizer is an adipic acid ether ester plasticizer.

11. The sealing material according to claim 10, wherein the plasticizer is contained in an amount of 40 to 60 parts by weight relative to 100 parts by weight of the rubber component.
